(19) United States
(12) Patent Application Publication
(10) Pub. No.: US 2006/0274522 A1
(43) Pub. Date: Dec. 7, 2006

(54) Light fixture mounting bracket and method

(76) Inventors: Rodney Williams, Auburn, IN (US); Frank L. Roe, Wolcottville, IN (US)

Correspondence Address: TAYLOR & AUST, P.C., 142 SOUTH MAIN STREET, P. O. BOX 560, AVILLA, IN, 46710, US

(21) Appl. No.: 11/446,676

(22) Filed: Jun. 5, 2006

Related U.S. Application Data
(60) Provisional application No. 60/687,697, filed on Jun. 6, 2005.

(51) Int. Cl. F21S 4/00; F21S 8/06

(52) U.S. Cl. 362/217; 362/406

(57) ABSTRACT

A light fixture mounting bracket for mounting a linear light fixture, which includes a first bracket with a first stem and a first longitudinal section which extends approximately orthogonal from the first stem, and a second bracket connected to said first bracket and with a second stem and a second longitudinal section which extends approximately orthogonal from the second stem. A plurality of fasteners are connected to and extend from the second longitudinal section.

### CROSS REFERENCE TO RELATED APPLICATIONS

This is a non-provisional application based upon U.S. provisional patent application Ser. No. 60/687,697, entitled “LIGHT FIXTURE MOUNTING BRACKET AND METHOD”, filed Jun. 6, 2006.

### BACKGROUND OF THE INVENTION

1. Field of the Invention

The present invention relates to a light fixture mounting bracket and method, and, more particularly, to a light fixture mounting bracket and method for linear lighting.

2. Description of the Related Art

Light fixtures are known, and more particularly linear lighting fixtures, which in addition to providing suitable light for work areas, home, etc., also provide a decorative and/or aesthetic appeal to the indoor or outdoor environment. The linear light fixture is typically flush mounted, or nearly flush mounted, to a hung ceiling or mounted below a hung ceiling, or mounted in proximity to another ceiling type. Such a hung ceiling typically has a metal grid structure suspended from and below ceiling joists, and the metal grid structure typically includes runners on which the ceiling tiles rest, and these runners are in the form of an inverted T. A problem with mounting a linear light fixture is leveling the fixture, which can require counterweights, which can be a tedious and time consuming process. Also, linear light fixtures can come in a four foot, eight foot or twelve foot lengths, and for a particular design of bracket, different versions of the bracket may be required for the different lengths of fixtures. Further, linear light fixtures can be mounted in a surface mount configuration or a hanger cable suspension configuration, and mounting brackets need to accommodate the different configurations.

Mounting brackets are known which may be mounted around a T-shaped runner, however such brackets have no accommodations for leveling of the light fixture. Further, such mounting brackets are restricted to either a surface mount configuration or a cable suspension configuration.

What is needed in the art is a linear light fixture mounting bracket which can be used to level the fixture, which can accommodate different lengths of fixtures, and which can accommodate different mounting configurations.

### SUMMARY OF THE INVENTION

The present invention provides a linear light fixture mounting bracket with a plurality of fasteners for connection to and leveling of the linear light fixture, where the fasteners extend from one of two sides of the bracket, and the two sides of the bracket can be connected around a T-shaped ceiling runner, or connected to other ceiling configurations.

The invention comprises, in one form thereof, a light fixture mounting bracket for mounting a linear light fixture, which includes a first bracket having a first stem and a first longitudinal section which extends approximately orthogonal from the first stem, and a second bracket being connected to said first bracket and having a second stem and a second longitudinal section which extends approximately orthogonal from the second stem. A plurality of fasteners are connected to and extend from the second longitudinal section.

The invention comprises, in another form thereof, a linear light fixture including a source of light, a housing connected to the source of light and a light fixture mounting bracket connected to the housing. The light fixture mounting bracket includes a first bracket having a first stem and a first longitudinal section which extends approximately orthogonal from the first stem, and a second bracket being connected to said first bracket and having a second stem and a second longitudinal section which extends approximately orthogonal from the second stem. A plurality of fasteners are connected to and extend from the second longitudinal section.

The invention comprises, in yet another form thereof, a method of mounting a linear light fixture to a ceiling, including the steps of: providing at least one light fixture mounting bracket including a first bracket having a first stem and a first longitudinal section extending approximately orthogonal from the first stem, a second bracket being connected to said first bracket and having a second stem and a second longitudinal section extending approximately orthogonal from the second stem, and a plurality of fasteners connected to and extending from the second longitudinal section; connecting the linear light fixture to the plurality of fasteners; and leveling the linear light fixture using the plurality of fasteners.

An advantage of the present invention is that it can be used to mount and level a linear light fixture.

Another advantage of the present invention is that it can be used to level a linear light fixture without the use of counterweights.

Yet another advantage of the present invention is that it can be used with different lengths of linear light fixtures.

Yet another advantage of the present invention is that it can be mounted around and to a T-shaped runner of a suspended ceiling system.

Yet another advantage of the present invention is that it can be mounted to a hangar cable.

Yet another advantage of the present invention is that it can be mounted to a ceiling joist.

Yet another advantage of the present invention is that it can be mounted to a junction box.

Yet another advantage of the present invention is that it is cost effective to manufacture.

Yet another advantage of the present invention is that it can be made from a stamping process.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is fragmentary perspective view of an embodiment of a linear light fixture with a light fixture mounting bracket according to the present invention;

FIG. 2 is an exploded view of the light fixture mounting bracket of FIG. 1;

FIG. 3 is a fragmentary side view of the linear light fixture and light fixture mounting bracket of FIG. 1, with the bracket mounted to a junction box;

FIG. 4 is a fragmentary side view of the light fixture mounting bracket according to the present invention mounted to a ceiling joist; and

FIG. 5 is a fragmentary side view of the light fixture mounting bracket according to the present invention mounted to a hanger cable.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

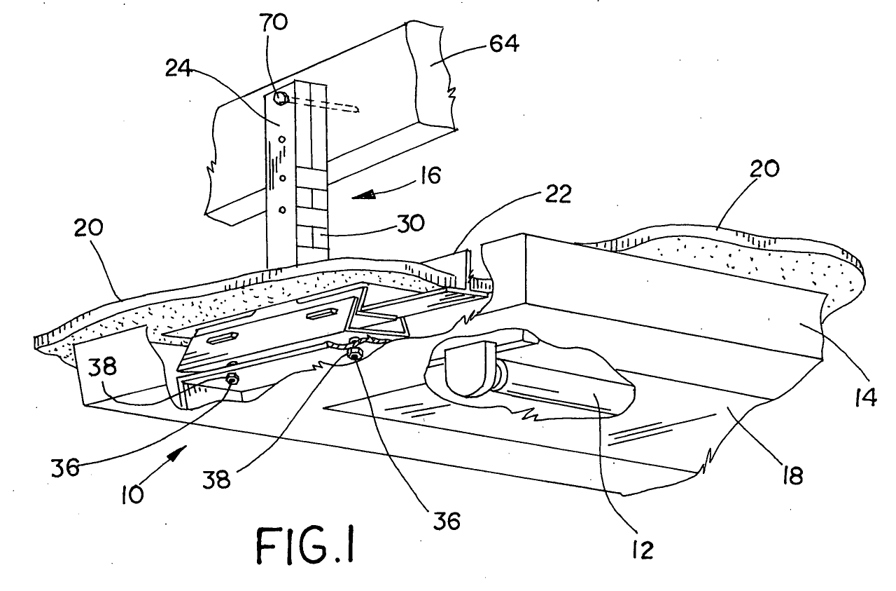

Referring now to the drawings, and more particularly to FIG. 1, there is shown a linear light fixture 10 which generally includes a source of light 12, a housing 14 connected to source of light 12, and a light fixture mounting bracket 16 connected to housing 14.

Linear light fixture 10 can include wiring, electrical/electronic controls, ballasts, reflectors (all not shown), and other components as are known, and can also include lens 18. Source of light 12 can be fluorescent bulbs, incandescent bulbs, metal halide bulbs, light emitting diode(s), lasers, other light sources and/or an array or combination thereof. Linear light fixture 10 can be used in conjunction with a suspended ceiling including ceiling tiles 20 and T-profile runner 22, for example.

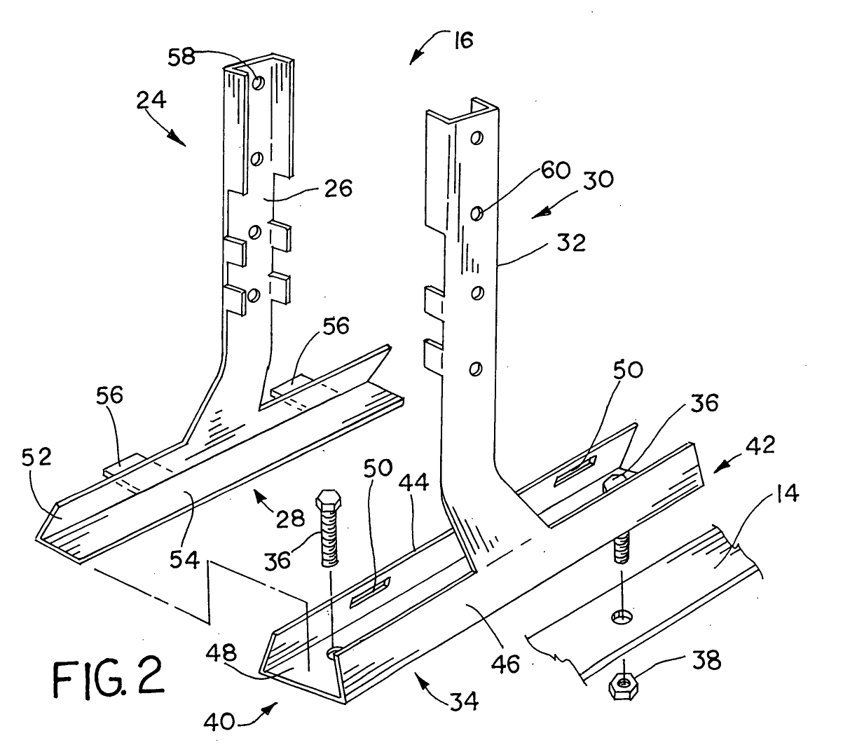

Referring more particularly to FIG. 2, light fixture mounting bracket 16 can include a first bracket 24 with a first stem 26 and a first longitudinal section 28 which extends approximately orthogonal from first stem 26. A second bracket 30 has a second stem 32 and a second longitudinal section 34 which extends approximately orthogonal from second stem 32. A plurality of fasteners 36 connected to and extending from second longitudinal section 34. Fasteners 36 can be screws, bolts and nuts 38, and the like.

Fasteners 36 can include two fasteners where one fastener 36 is connected to a first end 40 of second longitudinal section 34 and a second fastener 36 is connected to a second end 42 of second longitudinal section 34. Second longitudinal section 34 can include an approximately U-shaped cross-section (FIGS. 1-3) including a first side 44 opposed a second side 46, and a third side 48 between first side 44 and second side 46. Fasteners 36 can be mounted to third side 48. First side 44 can include at least one recess 50. First longitudinal section 28 can include an approximately L-shaped cross-section (FIGS. 1-3) which includes a fourth side 52 and a fifth side 54 which extends from fourth side 52, where fourth side 52 includes at least one interlocking tab 56 which can extend outwardly. Each of interlocking tabs 56 can connect with a corresponding one of recesses 50.

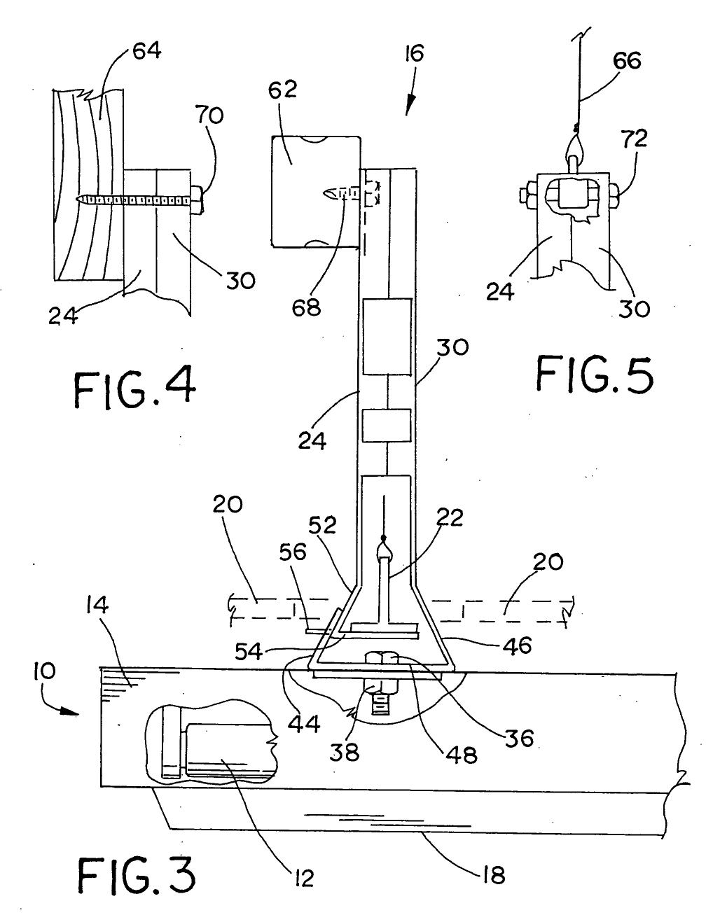

At least part of fasteners 36 can be mounted between third side 48 of second longitudinal section 34 and fifth side 54 of first longitudinal section 28, as shown particularly in FIG. 3. First stem 26 can include a first plurality of holes 58 and second stem 32 can include a second plurality of holes 60. When first bracket 24 is connected to second bracket 30 each of second holes 60 can be opposed to a corresponding one of first holes 58.

First longitudinal section 28 can be configured for mounting around at least part of T-profile ceiling runner 22; however, other mounting configurations are possible. For example, holes 58, 60 can be used to connect bracket 16 to junction box 62 using fastener 68 (FIG. 3), or can be used to connect bracket 16 to ceiling joist 64 using fastener 70 (FIG. 4), or can be used to connect bracket 16 to ceiling hanger cable 66 using fastener 72 (FIG. 5), all with or without the presence of a suspended ceiling including tiles 20 and runners 22.

In use, the present invention discloses a method of mounting linear light fixture 10 to ceiling 20, 22, or other ceiling elements, including the steps of: providing at least one light fixture mounting bracket 16 including first bracket 24 having first stem 26 and first longitudinal section 28 extending approximately orthogonal from first stem 26, a second side 46 having a second stem 32 and a second longitudinal section 34 extending approximately orthogonal from second stem 42, and a plurality of fasteners 36 being connected to and extending from second longitudinal section 34; connecting linear light fixture 10 to plurality of fasteners 36, and more particularly connecting fasteners to housing 14; and leveling linear light fixture 10 using fasteners 36. The method can further include the steps of connecting first longitudinal section 28 to T-profile runner, and/or connecting light fixture mounting bracket 16 to a hanger 66, and/or connecting light fixture mounting bracket 16 to ceiling joist 64, and/or connecting light fixture mounting bracket 16 to junction box 62.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A light fixture mounting bracket for mounting a linear light fixture, comprising:
a first bracket having a first stem and a first longitudinal section extending approximately orthogonal from said first stem;
a second bracket being connected to said first bracket and having a second stem and a second longitudinal section extending approximately orthogonal from said second stem; and
a plurality of fasteners connected to and extending from said second longitudinal section.

2. The light fixture mounting bracket of claim 1, wherein said plurality of fasteners comprises a first fastener connected to a first end of said second longitudinal section and a second fastener connected to a second end of said second longitudinal section.

3. The light fixture mounting bracket of claim 1, wherein said second longitudinal section includes an approximately U-shaped cross-section including a first side opposed a second side, and a third side between said first side and said second side, said plurality of fasteners mounted to said third side.

4. The light fixture mounting bracket of claim 3, wherein said first side includes at least one recess.

5. The light fixture mounting bracket of claim 4, wherein said first longitudinal section includes an approximately L-shaped cross-section including a fourth side and a fifth side extending from said fourth side, said fourth side including at least one interlocking tab extending outwardly, each said at least one interlocking tab for connection with a corresponding one of said at least one recess.

6. The light fixture mounting bracket of claim 5, wherein at least part of said plurality of fasteners are mounted between said third side of said second longitudinal section and said fifth side of said first longitudinal section.

7. The light fixture mounting bracket of claim 5, wherein said first longitudinal section is configured for mounting around at least part of a T-profile ceiling runner.

8. The light fixture mounting bracket of claim 1, wherein said first stem includes a first plurality of holes and said second stem includes a second plurality of holes, when said first bracket is connected to said second bracket each of said second plurality of holes is opposed to a corresponding one of first plurality of holes.

9. A linear light fixture, comprising:
a source of light;
a housing connected to said source of light;
a light fixture mounting bracket connected to said housing, said a light fixture mounting bracket including:
a first bracket having a first stem and a first longitudinal section extending approximately orthogonal from said first stem;
a second bracket being connected to said first bracket and having a second stem and a second longitudinal section extending approximately orthogonal from said second stem; and
a plurality of fasteners connected to and extending from said second longitudinal section.

10. The linear light fixture of claim 9, wherein said plurality of fasteners comprises a first fastener connected to a first end of said second longitudinal section and a second fastener connected to a second end of said second longitudinal section.

11. The linear light fixture of claim 9, wherein said second longitudinal section includes an approximately U-shaped cross-section including a first side opposed a second side, and a third side between said first side and said second side, said plurality of fasteners mounted to said third side.

12. The linear light fixture of claim 11, wherein said first side includes at least one recess.

13. The linear light fixture of claim 12, wherein said first longitudinal section includes an approximately L-shaped cross-section including a fourth side and a fifth side extending from said fourth side, said fourth side including at least one interlocking tab extending outwardly, each said at least one interlocking tab for connection with a corresponding one of said at least one recess.

14. The linear light fixture of claim 13, wherein at least part of said plurality of fasteners are mounted between said third side of said second longitudinal section and said fifth side of said first longitudinal section.

15. The linear light fixture of claim 13, wherein said first longitudinal section is configured for mounting around at least part of a T-profile ceiling runner.

16. The linear light fixture of claim 9, wherein said first stem includes a first plurality of holes and said second stem includes a second plurality of holes, when said first bracket is connected to said second bracket each of said second plurality of holes is opposed to a corresponding one of first plurality of holes.

17. A method of mounting a linear light fixture to a ceiling, comprising the steps of:
providing at least one light fixture mounting bracket including a first bracket having a first stem and a first longitudinal section extending approximately orthogonal from said first stem, a second bracket being connected to said first bracket and having a second stem and a second longitudinal section extending approximately orthogonal from said second stem, and a plurality of fasteners being connected to and extending from said second longitudinal section;
connecting said linear light fixture to said plurality of fasteners; and
leveling said linear light fixture using said plurality of fasteners.

18. The method of claim 17, wherein the ceiling is a suspended ceiling including a T-profile runner, further including the step of connecting said first longitudinal section to said T-profile runner.

19. The method of claim 17, further including the step of connecting said light fixture mounting bracket to a hanger.

20. The method of claim 17, further including the step of connecting said light fixture mounting bracket to a ceiling joist.

21. The method of claim 17, further including the step of connecting said light fixture mounting bracket to a junction box.
